(19) United States
(12) Patent Application Publication
(10) Pub. No.: US 2004/0258611 A1
(43) Pub. Date: Dec. 23, 2004

(54) Colloidal composite sol gel formulation with an expanded gel network for making thick inorganic coatings

(76) Inventors: Mark Barrow, Brampton (CA); Tim Olding, Kingston (CA)

Correspondence Address: DOWELL & DOWELL PC, 2111 Eisenhower Ave., Suite 406, Alexandria, VA, 22314, US

(21) Appl. No.: 10/601,364

(22) Filed: Jun. 23, 2003

(51) Int. Cl. B05D 3/02; C01F 7/02

(52) U.S. Cl. 423/625; 427/372.2

(57) ABSTRACT

A sol gel formulation and process for making thick coatings. In accordance with the teachings of this invention, sol gel coating layers of up to 300 microns in thickness can be provided in a single deposition.

### BACKGROUND OF THE INVENTION

The present invention relates to a process for depositing thick layers of ceramic coating on a range of substrate materials. More particularly this invention relates to a composition for making a sol gel composite coating, which can be deposited in layers of 100 microns or more in a single deposition. A sol gel composite coating is a film that is prepared from a slurry consisting of ceramic particles dispersed in a sol gel solution of metal organic precursors.

Ceramic materials attract a great deal of interest because they offer unique properties. These include hardness, wear resistance, corrosion resistance, high dielectric strength and large surface area. Ceramic coatings offer the potential to impart these properties on to other materials including metals and other ceramics.

Ceramic coatings can be prepared by thermal (flame, arc, plasma or HVOF) spray, by physical or chemical vapour deposition and by chemical means. Thermal spray involves using a high temperature environment to melt ceramic material and then spray that material on to the substrate to be coated. The material cools on contact and sticks to the substrate. Films up to 25 mm can be made in this manner. One of the drawbacks to this approach is that only line of site geometries can be successfully coated. PVD and CVD techniques use expensive vacuum chambers to deposit ceramic coatings. Using these techniques coatings are deposited angstroms at a time and several hours is required to build up 50 to 100 microns in thickness.

Chemical methods of fabricating ceramic coatings include sol gel processing and the composite sol gel method. In sol gel processing, metal organic precursor compounds of the desired ceramic oxide are mixed in a suitable solvent. The resulting solution is then hydrolyzed to form a structured solution or a gel containing metal organic polymers that convert to the inorganic ceramic oxide when fired. These solutions can be deposited onto a substrate by spray, dip or spin coating as well as by painting. The substrate and the film are then fired to convert the polymeric coating to its ceramic analogue. Even though the firing time is fast, a thickness of only up to 1 micron can be deposited in a single layer. Otherwise the stresses induced by shrinkage during the firing process result in cracks and delamination.

This thickness limitation has been partially addressed by Barrow et al., in U.S. Pat. No. Re 36,573, which discloses a method for producing thicker coatings by loading a conventional sol gel solution that would be used to make thin coating with up to 90% of finely divided ceramic particles. The slurry can be spun, spray, dip or screen printed as well as painted onto a substrate and then fired to remove the organic component and to develop an inorganic film. Using this approach Barrow et al were able to deposit up to 6 microns in a single layer and up to 200 microns with multiple depositions.

Troczynski et al. in U.S. Pat. No. 6,284,682 demonstrated that by using the colloidal recipe proposed by Yoldas in U.S. Pat. No. 4,614,673, thicker layers could be achieved in a single deposit. By making a slurry of 0.3 micron alumina powder in a colloidal alumina sol gel with a molar ratio of 1 and that has been peptized to a pH of 4, Troczynski et al. were able to deposit coatings of up to 80 microns in a single layer and up to 500 microns in multiple deposits. However, this formulation is again not suitable for dispersing larger particles and is prone to gellation when mixed with reactive particles such as high surface area gamma alumina.

There are many applications of ceramic coatings that require even thicker layers than 500 microns. An example of one application is catalyst support coatings where a catalytic material is impregnated into the pores of the ceramic layer. In such cases thick films in excess of 1 mm are required. In order to deposit such thick layers, the formulation needs to be thixotropic so that it is viscous enough to uniformly disperse large particles, but can be thinned temporarily (by shear mixing) so that it is able to flow.

### SUMMARY OF INVENTION

The present invention provides a composition for depositing sol gel composite coating layers up to 300 microns in thickness in a single deposition. The composition includes a colloidal sol gel formulation in which the gel structure has been modified so that when it is mixed with ceramic powders greater than 0.5 microns in particle size, the resulting slurry can be deposited in thick layers without delaminating. The specific composition is based on a colloidal sol gel system, but instead of having the continuous, dense network of the Yoldas system (which requires that the molar ratio of acid to metal alkoxide be in the range of 0.03-0.1), the gel structure has been expanded preferably to the point where it separates and forms a discontinuous network. This may be accomplished by increasing the molar ratio of the acid to the metal alkoxide used to prepare the gel structure to a point where it expands and preferably to a point where it prevents the formation of a continuous bonded gel network. Instead of the dense, compact structure of the Yoldas recipe, the increased acid concentration results in strong repulsive forces within the sol, increasing the distance between the colloidal particles eventually forcing the sol to form a solid like gel structure consisting of a series of discretely bonded networks.

This type of gel structure is ideally suited to making thick sol gel composite coatings. These expanded or discretely bonded gel networks are more porous (due to an expanded gel volume caused by strong repulsive forces) than a network made at lower acid/metal alkoxide molar ratios. In a sol gel composite formulation, these expanded or discretely bonded gel networks will position themselves between the particles which make up ceramic powder and much like mortar binds brick, binds the particles together and anchors the coating to the substrate. Due to the increased gel volume, these expanded or discretely bonded gel networks are sufficiently porous that they can be deposited in thick layers onto a surface without cracking or delaminating. The combination of the porosity in the bonded networks and the porosity inherent in sol gel composite coatings is sufficient to relieve the stresses produced in thick layers during firing and gel shrinkage.

Another advantage of the gel structure formed with increased molar ratio of acid to metal alkoxide is that at a specific ratio the gel becomes thixotropic and can be shear thinned. The viscosity of the gel increases with increased acid concentration. This makes it more suitable for holding large particles in a tight gel suspension. However as the gel is thixotropic the viscosity of the gel can be temporarily reduced to a point where the material can flow. The reduction in viscosity that is achievable by shear mixing is so dramatic that a structure that is completely gelled can be thinned sufficiently to flow easily through the inside of channels that are less than 1 mm² square.

Yet another advantage of the expanded gel volume is that its gel structure is highly stable and difficult to modify. This stability is important in thick gamma alumina washcoats for honeycomb structures used in catalysis. If gamma alumina powder is dispersed in a colloidal alumina sol gel with a molar acid to metal alkoxide ratio of 0.03-0.12, the gamma alumina increases the pH of the solution causing gelation. The higher the pH the faster this occurs. By using the gel structure that is the subject of this invention, it is possible to add gamma alumina powder with only a moderate increase in the pH. The tightly bonded, stable gel network is essentially able to maintain a suitable acidity and is not neutralized by the gamma alumina powder.

According to the present invention the formulation should have a molar ratio of acid to metal alkoxide that is greater than or equal to 0.1 for an inorganic acid and greater than or equal to 0.25 for an organic acid. These values represent limits where the gel volumes of colloidal sol gel films made from metal organic precursors become sufficiently expanded to produce thick coatings.

### DESCRIPTION OF PREFERRED EMBODIMENTS

As disclosed in U.S. Pat. No. Re. 36,573, thick film ceramic coatings may be produced by loading conventional sol gel solutions with up to 90% by weight of finely divided ceramic particles. The resulting slurry or paint can be either spun or dip coated or sprayed or painted or screen-printed onto a planar or non-planar substrate, then fired to remove the organic materials and to develop a microcrystalline structure. This patent claims coatings up to about 6 microns in a single layer can be deposited.

As demonstrated in U.S. Pat. No. 6,284,682 (Trocyzynski et al.), one particular recipe is to make a slurry consisting of 0.3 micron alumina powder in a colloidal alumina sol gel solution. Following the recipe of Yoldas, the colloidal alumina is 1 molar and has a pH of 4. This pH corresponds to an alumina sol gel solution with a molar ratio of acid to metal alkoxide that is in the range 0.03-0.1 near the Yoldas preferred ratio of 0.07. With this approach, coatings of up to 80 microns in a single layer can be deposited. This specific formulation exhibits Newtonian flow characteristics and is not ideally suited for dispersing larger particles and/or reactive ceramic powder such as high surface area gamma alumina.

According to the present invention, a thixotropic slurry composition can be made that enables the deposition of substantially thicker layers in a single deposition. By preparing a composite sol gel formulation with a colloidal metal alkoxide sol gel component with a specific gel structure, coatings in excess of 300 microns can be deposited in a single layer and in excess of 1.5 mm in multiple layers.

The colloidal metal alkoxide sol gel solution in the composition disclosed herein, is preferably one with a gel structure that is sufficiently expanded so that it begins to separate. A suitable sol gel may be produced according to the recipes taught by Yoldas as referenced above but wherein the molar ratio of the acid to metal alkoxide is adjusted during peptization to about 0.15 or greater for inorganic acids and about 0.25 or greater for organic acids.

The colloidal sol gel described herein can be thixotropic and has sufficient viscosity that ceramic particles that are greater than 0.5 microns in particle size can be dispersed in the solution and the particles will remain suspended indefinitely. This viscous slurry can be temporarily thinned and made to flow by shear thinning.

The colloidal sol gel can be alumina, titania, silica or zirconia as well as mixtures thereof. Typical metal organic precursors include aluminum isopropoxide, aluminum propoxide, aluminum n-butoxide, aluminum sec-butoxide, aluminum tert-butoxide, aluminum methoxide, aluminum ethoxide, tetraethyl orthosilicate, zirconium-n-propoxide, titanium isopropoxide.

Sol gel slurries suitable for depositing thick coatings in a single layer may be prepared by mixing up to 90% by weight of ceramic particles larger than 0.5 microns in size into a colloidal metal organic sol gel solution with a gel structure that is expanded preferably to the point where the continuous gel is starting to separate. A 30-60% loading is preferred. The slurry is then mixed to disperse the ceramic powder throughout the viscous gel.

The inorganic powder can be a ceramic such as for example oxide, nitride, carbide, boride or silicide. It can be selected from a wide range of materials including alpha alumina, gamma alumina, silica, titania, zirconia, silicon carbide, aluminum nitride, titanium carbide, tungsten carbide, silicon nitride, zirconium nitride, titanium diboride, molybdenum disilicide and graphite. Alternatively the inorganic powder can be a metal, such as silver, as long as it doesn't suffer deleterious reaction with the acid.

Typically the ceramic powder will have a particle size between 1 and 20 microns. However, in some cases it may be desirable to have a particle size as large as about 100 microns or as small as about 0.5 microns.

Typically the colloidal metal organic sol gel solution will have an alkoxide molar concentration of 1 to 1.5, however sometimes it may be desirable to have a molar concentration as low as 0.5 and as high as 2.

The preferred molar ratio of inorganic acid to metal alkoxide in the solution is 0.15 to 0.5. However, sometimes it may be preferable to have a ratio as low as 0.10 or as high as 1.0.

The preferred molar ratio of organic acid to metal alkoxide in the solution is 0.5 to 2.0. However, sometimes it may be preferable to have a ratio as low as 0.25 or as high as 4.0.

The inorganic acid can for example be nitric acid, hydrochloric acid or perchloric acid.

The organic acid can for example be acetic acid, monochloroacetic acid, dichloroacetic acid, trichloroacetic acid and formic acid.

A typical slurry may be prepared by dispersing 50 parts by weight of ceramic particles into 100 parts by weight of a colloidal alumina sol gel with the appropriate gel structure. The slurry should be mixed to uniformly disperse the ceramic particles in the sol gel solution. After mixing the slurry will form a viscous gel. If the molar ratio of acid to alkoxide is high enough the gel will become a thixotropic, solid like gel. However, due to the thixotropic nature of the gel, the viscosity of the slurry can be temporarily reduced by shear mixing and made to flow so that it is suitable for coating purposes by shear thinning. Once the thinning has stopped, the gel will slowly revert back to its original viscous state.

The slurries described herein can be deposited onto any suitable substrate by dipping, spin coating, screen printing, spray coating or by painting. Planar, coaxial and complex geometry substrates can be readily coated. Examples of suitable substrates include metals, glass, ceramics and thermoplastics. Examples of possible substrate geometries include planar pieces, the inside and outside of tubes, the inside channels of high density honeycomb monoliths, non-uniform curved surfaces and other complex shapes. Films in excess of 300 microns can be deposited in a single layer and over several mm can be deposited with multiple depositions.

Following the deposition of the slurry on to a substrate, it is heated in air to a temperature between 300° C. and 700° C. for several minutes to remove the organic material from the sol gel solution and form an inorganic ceramic layer. After the first firing, additional layers may be deposited and fired until the desired coating thickness is obtained.

Another aspect of this invention is a formulation for making thick catalytic support coatings or washcoats. Particularly a formulation may be used to prepare thick support coatings on the interior surface of a catalytic support structure. A typical washcoat formulation is prepared by mixing a colloidal alumina sol gel solution prepared from an aluminum alkoxide, with high surface area gamma alumina powder. The colloidal alumina sol gel solution must have a molar ratio of acid to metal alkoxide that is 0.1 or above and the pH must be less than 3.8. Formulations made with a pH of 3.8 and greater will experience uncontrollable gelation over time when mixed with gamma alumina powder and are not suitable for depositing thick washcoats. A colloidal alumina sol gel solution with a pH of 3.6 or lower is preferred.

A typical washcoat recipe consists of mixing 50 parts of gamma alumina powder (with particles in the 1-20 micron range) with 150 parts of a colloidal alumina sol gel made from an aluminum isopropoxide with the molar ratio of acid to aluminum alkoxide of greater than 0.15. This formulation can be used to deposit thick washcoat layers on the inside channels of honeycomb monoliths. A coating in excess of 300 microns in thickness can be deposited in a single layer. The thick coating is fired to remove the organic component leaving an inorganic high surface area material. This process can be repeated to achieve a total thickness of at least 1.5 mm.

As an alternative to adding an inorganic acid, salts may be used that become acid in solution, such as for example NaCl. To be effective such a salt should yield an acid having an ionization constant of at least 1×10⁻⁵ and have a noncomplexing anion with the metal species of the alkoxide.

### EXAMPLES

### Example 1

A composite sol gel formulation was made using a 1.25 molar alumina sol gel that was prepared by mixing aluminum isoproproxide with hot water and peptizing with nitric acid so that the molar ratio of acid to aluminum alkoxide was 0.25 and the pH was about 3.2. 50 parts of gamma alumina were mixed with 120 parts of this alumina sol gel. Water was added to adjust the alumina sol gel concentration to 1 mole per liter of solution. The resulting slurry was mixed so that powders are uniformly dispersed.

This solution could be used to coat the inside channels of cordierite honeycomb monoliths having 100 channels per square inch. The monolith was submerged into the composite sol gel formulation so that all the channels filled with liquid. The monolith was then withdrawn from the solution and excess coating was removed using compressed air. The coating was then fired up to 700° C. It was found that a coating with sections that are over 200 microns in thickness could be deposited in a single layer. A thickness of 1.5 mm could be achieved in 7 depositions.

### Example 2

A composite sol gel formulation was prepared according to the procedure described in Example 1 except that the molar ratio of the nitric acid to the aluminum alkoxide was 0.15 and the pH was about 3.5.

This solution could be used to coat the inside channels of cordierite honeycomb monoliths having 100 channels per square inch. A coating with sections of over 100 microns in thickness can be deposited in a single thickness. A thickness of 600 microns could be deposited in 6 layers.

### Example 3

A composite sol gel formulation was prepared by mixing an alumina sol gel prepared as described in Example 1, with an acid/aluminum alkoxide molar ratio of 0.25 with SiC powder with an average particle size of 20 microns. The resulting slurry was spray deposited onto a stainless steel substrate until a coating thickness of greater than 100 microns was achieved. The coating was fired to convert the film to an inorganic ceramic layer. This process was repeated 5 times for a total thickness exceeding 500 microns.

### Example 4

A composite sol gel formulation was prepared by mixing an alumina sol gel prepared as described in Example 1, with an acid/aluminum alkoxide molar ratio of 0.25 with alpha alumina powder with an average particle size of 20 microns. The resulting slurry was spray deposited onto a stainless steel substrate until a coating thickness of 100 microns was achieved. The coating was fired to convert the film to an inorganic ceramic layer. This process was repeated 5 times for a total thickness exceeding 500 microns

### Example 5

A composite sol gel formulation was prepared by mixing an alumina sol gel prepared as described in Example 1, with an acid/aluminum alkoxide ratio of 0.25 with alpha alumina powder with an average particle size of 5 microns. The resulting slurry was spray deposited onto a stainless steel substrate until a coating thickness of 50 microns was achieved. The coating was fired to convert the film to an inorganic ceramic layer. This process was repeated 10 times for a total thickness exceeding 500 microns

### Example 6

A composite sol gel formulation was prepared by mixing aluminum isopropoxide with hot water and peptizing with nitric acid for a molar ratio of acid to aluminum alkoxide of 0.50. The molar concentration of this solution was 1.0 and the pH was about 2.7. 100 parts of gamma alumina were mixed with 150 parts of the alumina sol gel. The resulting slurry was mixed so that powders were uniformly dispersed.

This solution could be used to coat the inside channels of cordierite honeycomb monoliths having 100 channels per square inch. The monolith was submerged into the composite sol gel formulation so that all the channels filled with liquid. The monolith was then withdrawn from the solution and excess coating was removed using compressed air. The coating was then fired up to 700° C. A coating with sections that are over 300 microns in thickness could be deposited in a single layer. A thickness of about 1.0 mm could be achieved in 3 depositions.

### Example 7

A composite sol gel formulation was made using an alumina sol gel that was prepared by mixing aluminum isoproproxide with hot water and peptizing with hydrochloric acid so that the molar ratio of acid to aluminum alkoxide was 0.25, the molar concentration of this solution was 1.0 and the pH was about 3.1. 50 parts of gamma alumina was mixed with 150 parts of the alumina sol gel. The resulting slurry was mixed so that powders were uniformly dispersed.

This solution could be used to coat the inside channels of cordierite honeycomb monoliths having 100 channels per square inch. The monolith was submerged into the composite sol gel formulation so that all the channels filled with liquid. The monolith was then withdrawn from the solution and excess coating was removed using compressed air. The coating was then fired up to 700° C. A coating with sections that are over 100 microns in thickness could be deposited in a single layer. A thickness of about 500 microns could be achieved in 5 depositions

### Example 8

A composite sol gel formulation was made using an alumina sol gel that was prepared by mixing aluminum isoproproxide with hot water and peptized using glacial acetic acid so that the molar ratio of acid to aluminum alkoxide was 0.50, the molar concentration of the solution was 1.0 and the pH was about 3.6. 50 parts of gamma alumina were mixed with 150 parts of the alumina sol gel. The resulting slurry was mixed so that powders were uniformly dispersed.

This solution could be used to coat the inside channels of cordierite honeycomb monoliths having 100 channels per square inch. The monolith was submerged into the composite sol gel formulation so that all the channels filled with liquid. The monolith was then withdrawn from the solution and excess coating was removed using compressed air. The coating was then fired up to 700° C. A coating with sections that are over 80 microns in thickness could be deposited in a single layer. A thickness of about 240 microns could be achieved with multiple depositions.

The above description is intended in an illustrative rather than a restrictive sense. Variations may be apparent to those skilled in the art without departing from the spirit and scope of the invention as defined by the claims set out below.

1. A composite sol gel formulation comprising:
a slurry having up to 90% by weight of inorganic powder dispersed in a colloidal sol gel solution prepared from metal organic precursors wherein said sol gel solution has an expanded and preferably discontinuous gel network;
said coating layer converting to a thick inorganic coating upon firing to a temperature of at least 300° C.

2. The composite sol gel solution of claim 1 wherein:
said colloidal sol gel is made by hot water peptization of metal alkoxide with an acid;
said acid having an ionization constant of at least 1×10⁻⁵, a noncomplexing anion with the metal species of the alkoxide; and,
the molar ratio of said acid to said metal alkoxide is selected to cause said gel network to be expanded and preferably discontinuous.

3. The composite sol gel solution of claim 2 wherein said colloidal sol gel solution contains an inorganic acid and has an acid/metal alkoxide molar ratio greater than 0.10.

4. The composite sol gel solution of claim 3 wherein:
said acid/metal alkoxide molar ratio is from 0.15 to 1.0; and, said slurry has a thixotropic nature enabling its application to a substrate by shear thinning followed by coating on said substrate and subsequent re-gelling.

5. The composite sol gel solution of claim 2, 3 or 4 wherein said inorganic acid is a member selected from the group consisting of nitric acid, hydrochloric acid and perchloric acid.

6. The composite sol gel formulation of claim 2, 3 or 4 wherein said acid has been produced by adding a water soluble acid salt having a noncomplexing anion with the metal species of the alkoxide.

7. The composite sol gel formulation of claim 2 wherein said colloidal sol gel contains an organic acid and has an acid/metal alkoxide molar ratio of greater than 0.25.

8. The composite sold gel formulation of claim 7 wherein:
said acid/metal alkoxide molar ratio is from 0.5 to 4.0; and
said slurry has a thixotropic nature enabling its application to a substrate by shear thinning followed by coating on said substrate and subsequent re-gelling.

9. The composite sol gel formulation of claim 7 or 8 wherein said organic acid is a member selected from the group consisting of monochloroacetic acid, dichloroacetic acid, trichloroacetic acid and formic acid.

10. The composite sol gel formulation of claim 1 wherein said colloidal sol gel is alumina.

11. The composite sol gel formulation of claim 10 wherein said alumina sol gel is made from a member selected from the group consisting of aluminum isopropoxide, aluminum propoxide, aluminum n-butoxide, aluminum sec-butoxide, aluminum tert-butoxide, aluminum methoxide and aluminum ethoxide.

12. The composite sol gel formulation of claim 1 wherein said colloidal sol gel is at least one member selected from the group consisting of alumina, titania, zirconia and silica.

13. The composite sold gel formulation of claim 1 wherein said colloidal sol gel solution has a pH of no greater than 3.8.

14. The composite sol gel formulation of claim 1 wherein said colloidal sol gel solution has a pH of no greater than 3.6.

15. The composite sol gel formulation of claim 1 wherein said colloidal sol gel solution has an alkoxide molar concentration of between 0.5 and 2.0.

16. The composite sol gel formulation of claim 1 wherein said inorganic powder is a member selected from the group consisting of oxide, nitride, carbide, silicide, graphite and silver.

17. The composite sol gel formulation of claim 1 wherein said ceramic coating is at least 100 microns thick.

18. The composite sol gel formulation of claim 1 wherein said formulation is capable of forming a ceramic coating of at least 1 mm thick by repeated coating and firing.

19. The composite sol gel formulation of claim 1 wherein said inorganic powder has an average particle size of from 1 to 100 microns.

20. The composite sol gel formulation of claim 1 wherein said inorganic powder has an average particle size of from 1 to 30 microns.

21. A process for producing a gamma alumina washcoat on inside channels of honeycomb monoliths and close packed structures comprising the steps of:
(i) forming a slurry having up to 90% by weight high surface area ceramic powder in a colloidal alumina sol gel containing an acid and a metal alkoxide;
(ii) said acid having an ionization constant of at least 1×10⁻⁵ and having a nomcomplexing anion with the metal species of the alkoxide;
(iii) increasing the molar ratio of said acid to said metal alkoxide to cause said gel network to become expanded and preferably discontinuous;
(iv) coating said inside channels with said slurry to form a coating layer thereon;
(v) allowing said coating layer to gel;
(vi) converting said coating layer to a ceramic layer by firing to a temperature of at least 300° C.;
(vii) repeating steps (iv) through (vi) as necessary to form a ceramic coating having a desired thickness.

22. The process of claim 21 wherein:
said high surface area ceramic powder is a member selected from the group consisting of gamma alumina, silica, alumina-silica, titania and zirconia.

23. The process of claim 21 wherein said metal alkoxide is a member selected from the group consisting of aluminum isopropoxide, aluminum propoxide, aluminum n-butoxide, aluminum sec-butoxide, aluminum tert-butoxide, aluminum methoxide and aluminum ethoxide.

24. The process of claim 21 wherein said colloidal sol gel is a mixture of alumina and another metal oxide.

25. The process of claim 24 wherein said other metal oxide is a member selected from the group consisting of zirconia, silica, titania and magnesia.

26. The process of claim 21 wherein said acid is an inorganic acid and said molar ratio is increased in step (iii) to a molar ratio of greater than 0.10.

27. The process of claim 26 wherein said molar ratio is from 0.15 to 1.0; and,
said slurry has a thixotropic nature enabling its application to said inside channels by shear thinning followed by coating on said inside channels and subsequent re-gelling.

28. The process of claims 21, 26 or 27 wherein said acid is a member selected from the group consisting of nitric acid, hydrochloric acid, perchloric acid, and an acid produced by adding a water soluble acid salt having a noncomplexing anion with the metal species of the alkoxide.

29. The process of claim 21 wherein said acid is an organic and in step (iii) is added in an amount sufficient to cause said molar ratio to be greater than 0.25.

30. The process of claim 29 wherein said acid is added in an amount sufficient to yield a molar ratio of from 0.25 to 2.0; and,
said slurry has a thixotropic nature enabling its application to said inside channels by shear thinning followed by coating on said inside channels and subsequent re-gelling.

31. The process of claim 29 or 30 wherein said acid is a member selected from the group consisting of acetic acid, monochloroacetic acid, dichloroacetic acid, trichloroacetic acid and formic acid.

32. The process of claim 21 wherein the colloidal sol gel has a pH not exceeding 3.8.

33. The process of claim 21 wherein the colloidal sol gel has a pH not exceeding 3.6.

34. The process of claim 21 wherein said desired thickness is at least 100 microns.

35. The process of claim 21 wherein said desired thickness is at least 200 microns.

36. The process of claim 21 wherein said desired thickness is at least 300 microns.

37. The process of claim 21 wherein said desired thickness is 1.5 mm.

38. The process of claim 21 wherein said gamma alumina has an average particle size of from 1 to 100 microns.

39. The process of claim 38 wherein said gamma alumina has an average particle size of from 1 to 20 microns.

40. A catalytic support structure having a thick sol gel washcoat produced according to the process of claim 21.

41. The catalytic support structure of claim 40, wherein:
said washcoat is applied to honeycomb monoliths;
said high surface area ceramic is selected from the group consisting of gamma alumina powder silica, alumina/silica blends, titania and zirconia.
said acid to metal alkoxide ratio in step (iii) is increased to cause said gel network to be thixotropic; and,
including the further step of shearing said slurry to form a shear thinned slurry for application in step (iv).
